(19) United States
(12) Patent Application Publication
(10) Pub. No.: US 2011/0068618 A1
(43) Pub. Date: Mar. 24, 2011

(54) CARTRIDGE-BASED HUB SYSTEM

(76) Inventors: Christian Antal, Oslo (NO); Knut Tore Ljøsne, Oslo (NO)

(21) Appl. No.: 12/994,073

(22) PCT Filed: May 27, 2009
(86) PCT No.: PCT/NO2009/000197

§ 371 Date: Nov. 22, 2010

(30) Foreign Application Priority Data
May 28, 2008 (NO) 20082471

(51) Int. Cl. B60B 27/02; B62M 11/16

(52) U.S. Cl. 301/110.5

(57) ABSTRACT

The present invention relates to a cartridge-based hub system for a bicycle with at least two frame stays, consisting of a hub shell that is fastened together with the hub wheel rim, and an internal detachable cartridge consisting of the typical elements that a hub contains, made in such a way that the cartridge can be detached from the hub shell and the rest of the wheel by a person not possessing the competence of a specialist, without exposing the inner mechanism. The cartridge-based hub system enables the cyclist to use the same cartridge on multiple wheel sets with for example different rim- and tire solutions, and to use different cartridges with different hub- and power transfer solutions on the same wheel set. Furthermore, a cartridge-based hub system enables the use of detachable power transfer solutions on wheels with synchronously arranged spokes, which strengthens the wheel and eases the process of building a wheel, compared to wheels with asynchronously arranged spokes. Furthermore, a cartridge-based hub system enables separate production and sale of hub systems and wheel sets.

The invention according to the present application concerns a hub system for a bicycle. More specifically, the invention concerns an encapsulation for the hub system of a bicycle, where a power transfer solution is mounted in a separate sealed cartridge, which with ease can be mounted onto and separated from the wheel-set of the bicycle, and where the detachable power transfer cartridge is designed for use on bicycle frames with two wheel stays and two axle mounts, one on each side of the wheel.

The power transfer solutions within the hubs of the bicycle enable the rider to propel the vehicle forward. Such solutions include gear systems. Gear systems on bicycles enable the rider to change gear ratio, and with this chose a suitable cadence as the speed, terrain or elevation varies. Hub gears for bicycles are known technology and most often consist of planetary gear systems or other gear systems for example stepless CVT-systems, mounted within the hub of the rear wheel on the bicycle. The gear system is operated by the rider with a shifter, most often connected to the gear box through a mechanical or hydraulically controlled wire. In the later years, old power transfer solutions such as single speed and fixie have experienced new interest.

Planetary gear systems is a known technology which has existed for more than 100 years and which has multiple areas of application, for example in automatic transmission for automobiles, power transfer solutions in windmills, mechanical wrist watches, and dedicated hub gears for bicycles. Such planetary gears mechanisms can be very reliable and robust relative to other gear systems for bicycles. They are usually built sealed and the delicate internal mechanisms are therefore not exposed to the outer elements, they can be more user friendly than other gear systems, as one only needs one gear shift unit and can save space in comparison with many other gear solutions as the cogs roll inside of each other. Planetary gear systems can also be built light enough for active use. A standard planetary gear solution typically consists of one or more planetary wheels which rotate between a central cog/sun wheel and an outer ring/annulus, and is typically mounted in a planetary holder, which can rotate relatively to the sun wheel and annulus. By locking or connecting these elements together, one will have available several gear ratios, and by combining several series with each other, one can make a system with a large number of gear ratios. The planetary gear system can be fabricated with different configurations, specifically for the intended use. It is for example not given which one of the three elements; sun wheel, planetary holder or outer ring that will function as driving unit, locking unit and the driven unit respectively.

Continuously Variable Transmission-systems (CVT), or Infinitely Variable Transmission-systems (IVT) are also known technologies, and consist of internal and sealed solutions that typically are mounted within the hub of the bicycle. CVT-gear solutions provide the rider with stepless gear transmission and thereby an infinite number of speeds within a range of gear ratios. This provides a limited number of gear ratios, in comparison with other mechanical gear systems such as for example planetary gear systems.

Single speed is a power transfer solution which implies that the bicycle is built with only one speed. Today's gear systems bring disadvantages such as power loss, need for maintenance, and complexity, which many find unattractive. Single speed has therefore experienced an increased interest. Riding on a single speed can be more demanding than riding a bicycle with several gear ratios, as one for example cannot select an easier ratio in an upwards sloping hill, or a harder ratio in a downwards sloping hill.

Fixie is an even more extreme power transfer solution, where the bicycle does not include a freewheeling solution, which means that the pedals at any time have to follow the wheels' movement. The fixie-rider will thereby always have to pedal with the same frequency as the wheel, which adds an extra element of challenge to the riding.

In traditional hub systems, the power transfer solution cannot be dismounted from the hub as a separate part. This problem is especially prominent with hub gears. There are two ways in which the internal mechanisms can be used on another wheel set. Either the complete hub with hub shell and spoke mounts will have to be dismounted from the wheel rim, which is a large operation and will require complete readjustment of the spokes. The second alternative is to open the hub, expose the delicate internal mechanisms, and move the internal gear mechanisms to another hub shell on another wheel set. In this case, the chance will increase that foreign elements will contaminate the system, thereby increasing the chance of critical failure. Frequent opening of the system will counter the original intention of using a sealed solution, namely increased reliability and robustness. The hub gear systems' lacking flexibility reduces the market's interest for such solutions.

Another normal gear solution for bicycles is the derailleur system. Such systems consist of open gear arms on the outside of the hub, one gear arm by the cog set on the hub, and one by the chain ring set that is mounted on the crank set. This gear solution is known for being light weight and simple, but also unreliable and not very robust. The gear arms are user operated, with one shifter each through a wire/cable, and they lift or push a chain from one cog on the cog set/chain ring set to another cog with a different size, thereby changing the gear ratio between the pedals and the wheel. The rear derailleur is equipped with a spring loaded arm that keeps the chain tensioned. The cog set on the rear hub is thus driven by a chain, and mounted onto the hub. More precisely, the cog set is mounted onto a boss that is mounted on the hub's right side and which occupies a large proportion of the space between the wheel axle mounts. The more gear ratios the solution is intended to provide, the more cogs the cog set will have to consist of. The cog set can, as opposed to the hub gear systems of today with ease be dismounted from the rear wheel and moved to another wheel set, which contributes to the attractivity of the solution from a user's point of view. Furthermore, the cog set can be fabricated separately from the hub, and lock-in to one manufacturer can thereby be achieved by preventing compatibility with other solutions, which contributes to the attractivity of the solution from the manufacturer's point of view.

An alternative gear system for bicycles according to Norwegian patent application 2007 3623 is sealed in the same manner as hub gears, but can be separated from the hub and from the wheel in the same manner as a cog set. Such gear boxes are mounted on the hub boss, which is located on the hub's right side. The hub shell is therefore on the hub's left side and not centered relatively to the wheel rim and the tire. As the spokes are mounted in this hub shell's outer rim, and there is a cog set on the hub's right side, the spokes will have to be asynchronously mounted to the hub, to ensure that the wheel rim and the tire will be centered relatively to the wheel axle mounts of the frame. This requires the spokes on the right and left side to be of different lengths and potentially different lacing patterns and to have different stretch-coefficients. Such a configuration hampers wheel-design and fabrication of the wheel, as the mechanic will have to take into consideration that the spokes on the right and the left side of the asymmetrical wheel will have to be tightened differently for the wheel rim and the tire to be centered relatively to the axle mounts of the bicycle wheel. Furthermore the wheel will be exposed to asynchronous load under use, which can increase the chance of failure of the wheel rim, tire, spokes, or spoke mounts. This is particularly a concern by the ever more popular disciplines within the sport of mountain biking such as all-mountain, free-ride, and downhill, where the stress on the equipment is particularly high and varying.

On dedicated hub gears on the other hand, there is no need for a cog set with many cogs, and the hub shell is therefore stretched relatively far out to the right and left side between the wheel axle mounts. Thus the spoke mounts on these hubs, in contrast to on boss-hubs, can be placed equally far from the wheel rim, so that the rim will be centered relatively to the wheel axle mounts. Hence, the spokes on the right and the left side of the hub will be equally long and the stretch-coefficient will be the same on the right and the left side of the wheel. Compared to wheels manufactured for derailleur systems, such a wheel is stronger, the wheel fabrication process is less demanding, and the design can be said to be more attractive.

Dedicated hub gears are however not easily transferred between vehicles or between wheels. One will have two options for using the hub gear on another bicycle or wheel. One is to disconnect the hub from the rim and the spokes, and move it to another bicycle. The spokes are disconnected by loosening each spoke nipple from the rim to the extent that the hub and the wheel can be separated, where after the hub gear is laced with another wheel rim and tire, potentially with different spokes. This is a time consuming and difficult process which requires the competence of a specialist. The alternative solution includes that one takes out the internal planetary gear system from the hub shell, expose the delicate internal mechanisms, and move it to a different hub shell. The mounting contraptions that attach the internal mechanisms to the hub shell and away from the elements are loosened, where after these delicate internal mechanisms are dismounted and installed in a different hub shell. To prevent the delicate internal mechanisms from being contaminated by impurities that can lead to critical failure of the hub gear by use in a contaminated state, this operation should be done in a sterile environment. It will therefore not be desired to change gear systems on a wheel set with such dedicated hub gears without having done careful preparation and cleansing of the workshop environment and tools. For example, it would be inconceivable to do such an operation on a bicycle close up to a race, unless the rider and his mechanics would have access to a sterile workshop environment. Furthermore, such a conversion process is time-consuming and complicated, and requires the competence of a specialist.

Another consideration to take is the fastening contraption between the hub and bicycle frame. The majority of bicycles today use frames with two wheel axle mounts and thereby two stays, one on each side of the wheel. Furthermore, a variety of different wheel axle mounts are used on such dual stay frames. Regular bicycles today can for example have wheel axle mounts that are more or less horizontal, for use with fixie or single speed. Thus the distance between the crank and the hub can be varied, which results in chain slack being taken up by the wheel and not by a separate spring loaded arm as with use of a rear derailleur. Alternatively, the bicycle can have vertical wheel axle mounts, in which the wheel with its axle is pushed upwards, without the axle necessarily being attached fully. To prevent the un-tensioned chain to derail, it should be tightened, either by a separate spring-loaded arm or by the spring-loaded arm in the rear derailleur. The axle is fastened with a fastening contraption, for example powerful nuts that are tightened to fasten the axle to the frame. An alternative to nuts are so called quick releases, with a lever that is pushed towards the frame, thus tightening fastening cups on the quick release against the hub so as to keep the frame and axle together. Yet another solution is a separable axle. The axle's fastening area to the frame will in this embodiment have a certain shape; it can be circular, or it can be oval or sided, so as to prevent rotation. This end is pushed into a countering track in the frame, before nuts on the frame are tightened and the axle is thereby held firmly attached to the frame. Such axles can be fabricated with different diameters and thicknesses, and can in certain instances be used across each other by use of adapters. One advantage of loose axles is that the contact area with the frame can increase, which reduces the opportunity of the axle to move independently of the frame, and the solution will be perceived as more rigid. This is particularly useful in demanding disciplines such as all-mountain, free-ride and downhill, where the stress on the equipment is particularly high and varying.

Patent GB 2400084 describes a hub system for bicycle with the specific characteristic that the system can be mounted on bicycles with only one chain stay positioned on the right side of the wheel, as opposed to bicycles with two chain stays, one on each side of the wheel. Such a single stay solution eases the process of detaching the tire and tube from the wheel compared with on bicycle wheels that have dual stay solutions, as wheels on such bicycles have to be detached from the bicycle for the tire and tube to be replaced. Furthermore, the spokes on the hub can be mounted synchronously relatively to a fictive set of wheel axle mounts on each side of the wheel. The stretch-coefficient of the spokes can then potentially be identical on the right and the left side of the wheel. Such synchronous mounting of the spokes strengthens the wheel and eases the building and adjustment of spoked wheels. A side-effect of this solution is that the wheel and the gear box can be separated without the wheel having to be rebuilt and the spokes readjusted, and without exposing the delicate inner mechanisms of the planetary gear system. What kind of inner gear solution is applied is not given by the patent.

There are clear technical disadvantages of use of merely one chain stay. The specially manufactured frame will have to have a unique, costly and complicated contraption for attaching the wheel, to prevent the wheel from giving in sideways, and to prevent instability during use. With instability, vibrations might arise which can shake parts loose on the bicycle or weaken the construction. This can cause critical failure, which can be dangerous for the rider and the surroundings. To achieve a necessary degree of stability and strength, the frame and the mounts will therefore have to be built more sturdy, which can be a disadvantage taken in regard weight, weight distribution on the bicycle, and other concerns that are natural to take into account when constructing a bicycle. On frames with two chain stays, on the other hand, the frame tubes and the attachment contraption together can be built less comprehensive that the one chain stay on a single stayed frame, and one can therefore save both material and weight by using a frame design with two stays. The wheel will rest against frame mounts on both the right and left side of the wheel, and will therefore not attempt to wander sideways when the wheel is exposed to opposing pressures, upwards from the ground, and downwards from the frame, such as wheels on single-stay frames will experience, without comprehensive strengthening of the construction.

Furthermore, a solution such as in GB 2400084 cannot be used on bicycles with two chain stays, as a single stay frame is required for the use of the above mentioned patent's hub solution. The hub system for single stay frames require special mounts on the frames. Regular wheels cannot be used on frames with one single stay, and vice versa. The hub system of GB 2400084 can therefore not be used on frames with two stays. Today's frames are mostly all dual stayed, which means that the solution cannot be used on the majority of frames on the market today. This reduces the market potential and hampers market penetration. The solution can therefore not be said to have been developed with particular concern for flexibility of frame selection or mass production. Lacking scale advantages causes the cost of production of such special solutions to be high, and the number of users to remain low, as the economy in acquiring and later selling custom parts is poor. However, in sticking with today's standards in the construction of components, the attractivity of the product and the realizable market potential will be greater.

One objective with the current invention is to provide a hub system for bicycles that enables separate mass production and assembly of a wheel; including its wheel rim, spokes and hub shell into one unit, and to separate mass production of the hub-based elements that a wheel typically contains, for example free-wheeling mechanism, main hub bearings, axle, and hub based power transfer mechanisms such as single speed-, fixie-, or gear solutions, and other relevant mechanisms and elements.

Another objective with the current invention is to provide a solution where a sealed cartridge with the typical inner hub mechanisms with ease and without the competence of a specialist can be attached to and detached from the wheel, to ease the use of the same inner hub mechanisms on several/different wheel sets, and ease the use of different inner hub mechanisms on the same wheel set, without the inner hub mechanisms being exposed.

Another objective with the current invention is to provide a type of sealed and detachable hub system that can be used on wheels with spokes of the same length, lacing patterns, and stretch-coefficient on the right and left side of the hub shell relative to the central wheel rim and the hub, so that the wheel can be built with greater ease and greater strength than wheels with asynchronously mounted spokes.

Another objective with the current invention is to provide an as above mentioned cartridge-based hub system that can be used on bicycles with two chain stays, for increased market potential, greater penetrative potential, increased manufacturer interest, better stability during use, and less stringent rigidity demands for frame and fastening contraptions etc.

For these objectives, a gear system for bicycles is provided, consisting of two main components, a hub shell and a cartridge. The hub shell consists in all simplicity of a loose metal shell consisting of none or just certain components that a hub typically consists of, such as axle, wheel bearings, free wheel mechanisms, and power transfer mechanism. The hub shell is attached to spokes, carbon wings or similar, which in the outer circumference are attached to the wheel rim and tire, so that this hub shell with other parts appear as nearly a complete wheel, though without the inner mechanisms that a wheel typically contains.

Furthermore, the inner part of the hub shell and/or the outer part of the cartridge's surface will be constructed with fastening mechanisms for mounting of a separate internal cartridge. The cartridge and the hub shell are manufactured independently of each other, but with the purpose of being capable of being connected together into one functional unit with equivalent or better function than current dedicated and non-detachable hub gear solutions. The cartridge's outer fastening mechanisms will make it possible to fasten the separate cartridge with the inner fastening mechanisms of the hub shell, so that these two elements together appear as one unit, and the system will with ease be able to be disassembled into the two separate parts, namely a cartridge and a hub shell.

The cartridge may contain power transfer solutions, wheel bearings, freewheel solution, and other mechanisms that are necessary for the wheel to have a value in use. These mechanisms can be fabricated as separate parts or as integrated parts of the cartridge. To mount the wheel onto the bicycle, the parts of the cartridge are assembled into a complete cartridge with its assigned function and purpose, and then mounted into the hub shell. The hub shell can either already be attached to the other parts—wheel rim, tire etc, which make the wheel usable for riding, or it can be attached to these parts after that the cartridge has been installed into the hub shell. The wheel is mounted to the bicycle in some manner appropriate, for example with some sort of quick release, bolts or nuts. The two units, the hub shell and the cartridge, can thereby with ease be united and separated. In other words, the system is unlike all existing hub solutions for bicycles with two wheel axle mounts in that the typical inner mechanisms of the hub such as wheel bearings, free wheel solution, power transfer solution and other mechanisms with ease and without exposing the delicate inner parts can be united with the wheel and its tire, wheel rim and hub shell, be separated, and again united.

The cartridge will be able to contain different types of internal power transfer solutions which offer different user experiences. One cartridge solution can contain a planetary gear system. This planetary gear system can contain one or more series, which will offer from two and up to a large number of different gear ratios. The more individual gear ratios the gear system has, the more alternative pedaling frequencies the rider can experience. Another solution can contain a CVT-gear system with stepless transmission. The rider may with such a solution be able to experience an infinite number of gear ratios. Another cartridge version can contain an encapsulated derailleur-solution. A further cartridge version can contain a single-speed cartridge, which means that the solution offers only one gear ratio. A further solution may contain a fixie-solution. Other power transfer solutions can be developed and mounted in the cartridge. Common for these solutions is that they can be used in a cartridge-based hub system in that the sealed cartridge with the inner solution is mounted into the hub shell on the wheel which is mounted onto the bicycle in its two chain stays. In principle, the critical element of the cartridge-based hub system is not what kind of inner power transfer solution one chooses for the sealed cartridge, but that the solution is cartridge-based and that this shall be usable on a standard dual stayed frame.

The encapsulation of the cartridge can be made in different manners. The shape can be circular, quadratic, star-formed, or with other usable shapes, insofar as the hub shell has such a shape that the objectives of the system are achieved. These include that the closed cartridge with its internal hub components and the complementary hub shell shall be easily unitable so as to be used as a complete hub system, and furthermore that it with an equal degree of ease can be separated. A purpose with the sealing and encapsulation is to protect the inner mechanisms to the degree of maintaining the reliability and robustness of the system. The cartridge will therefore primarily appear closed after being fabricated and ready for use, but it can also be fabricated with contraptions for easy access to the inner mechanisms should repairs, replacements or service be necessary.

The size of the hub shell will determine how large a cartridge can be used on the wheel, as the cartridge will have to fit into the hub shell and therefore cannot be larger than the hub shell. The cartridge can, however, be smaller than the hub shell, given that it can be attached in an appropriate manner for use, for example with some sort of adapter or transformer.

For attachment of cartridge to hub shell, different mechanisms can be used. One can use splines, threads or other types of fastening mechanisms, for example spring loaded or magnetic fastening mechanisms. Alternatively the cartridge can be attached with bolts or screws, clipped into place, screwed into place, glued into place or in some other manner be attached to the hub shell.

The system will first and foremost be used on bicycles with two wheel axle mounts, one on each side of the wheel. These wheel axle mounts will be attached to the frame and function as the contact point between the wheel and the frame. As to enable the wheel to roll freely relatively to the frame, wheel bearings will have to be mounted in this area of the bicycle. These will be detachable or integrated with the cartridge. The wheel axle mounts can be detachable or integrated with the frame. Furthermore, the wheel axle mounts will be attached to the chain stays or seat stays of the frame, or to both the chain stays and seat stays. Insofar as the frame has wheel axle mounts, it is irrelevant which shape they have or how they are attached to the frame. The wheel axle mounts can be vertical, horizontal, round, or of another shape, independent of the frame one has and what kind of axle one wishes to use with the cartridge.

The cartridge may use different axle standards for mounting of the same type of cartridge onto frames with different axle mount standards. With the cartridge-based hub solution, a variety of different axle solutions can be used, either an integrated axle or a separate axle, depending upon whether the cartridge has been fabricated for the one or the other solution. The axle can, as with today's hub gears, be an integrated part of the cartridge, which enables the use of the axle for the gear changing mechanisms as in today's hub gears and today's hub gear solutions will thereby easily be adaptable for this cartridge-based hub gear solution. Alternatively a loose axle can be applied, where the cartridge has an internal hole for mounting of a separate axle. This will give the user greater flexibility with regards to combinations of different frame and cartridge solutions. For an axle with a large diameter only an axle is used, for axles with a smaller diameter, an “adapter” is used, which makes the smaller axle fit with the relatively larger hole of the cartridge.

If the cartridge contains gear mechanisms these can be mechanically, hydraulically, or electrically controlled. The gear mechanism can be user operated through a shifter. Other solutions can be automative, in that the system itself registers factors such as speed, elevation, cadence etc, and chooses a gear ratio that fits the particular situation.

For those cartridges that contain a gear function controlled by a wire, the wire attachment point will preferably be constructed to ease detachment of the wire from the cartridge, to furthermore ease the detachment of the wheel and the gear box for maintenance or change of components.

The wheel and the cartridge are driven by the pedals of the bicycle through a power transfer solution from the pedals and the crank set, with a chain, a belt, a cardan, hydraulic transfer or other forms of power transfer. By use of a chain or belt, the chain wheel attached to the crank arms will rotate when the pedals are pedaled by the rider, and drives a chain that drives another chain wheel that is mounted to the cartridge.

The characteristic of the cartridge-based hub solution have now been described in general terms. A more detailed description of a preferred solution is presented below with references to the attached figures and models.

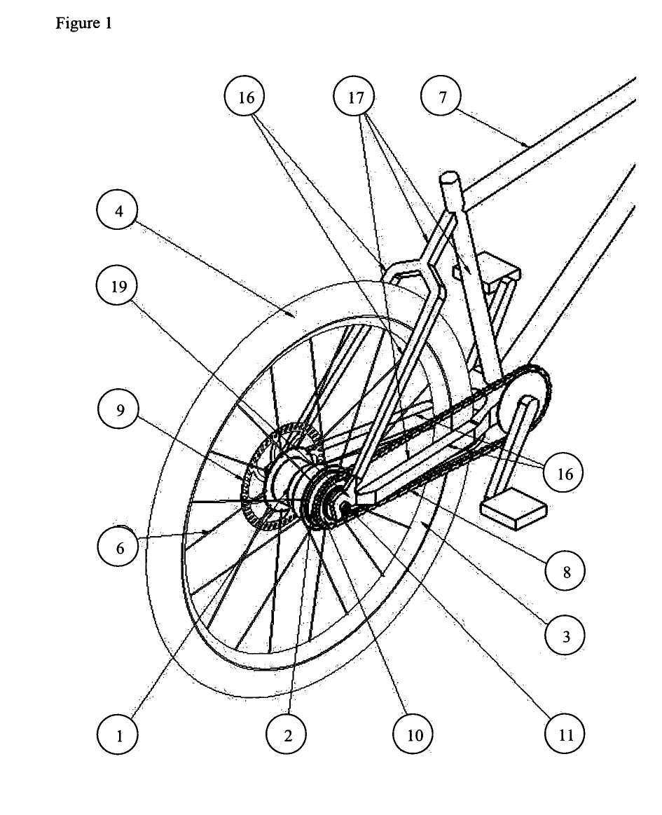

FIG. 1 shows a cartridge-based hub system according to the present invention, mounted in the rear wheel of a bicycle,

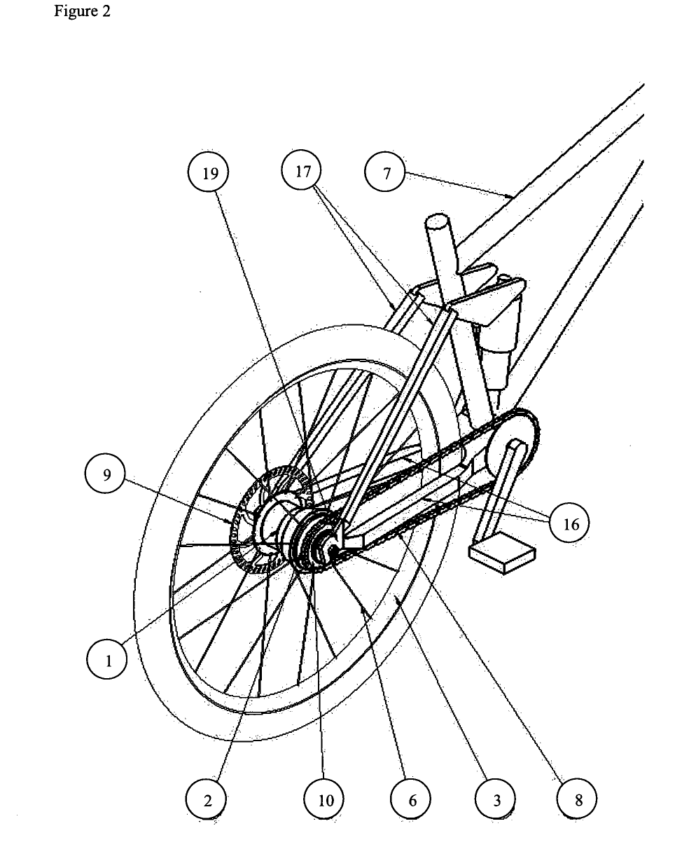

FIG. 2 shows the same cartridge-based hub system as above, but where the bicycle is equipped with suspension device for the rear wheel,

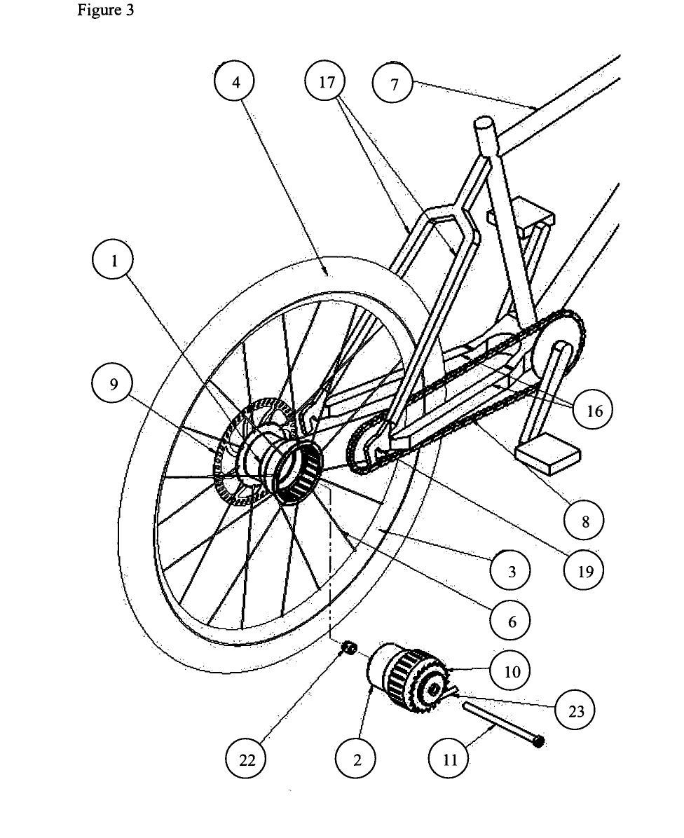

FIG. 3 shows a cartridge with a detachable axle on the cartridge-based hub system according to the present invention, after detachment from the bicycle frame,

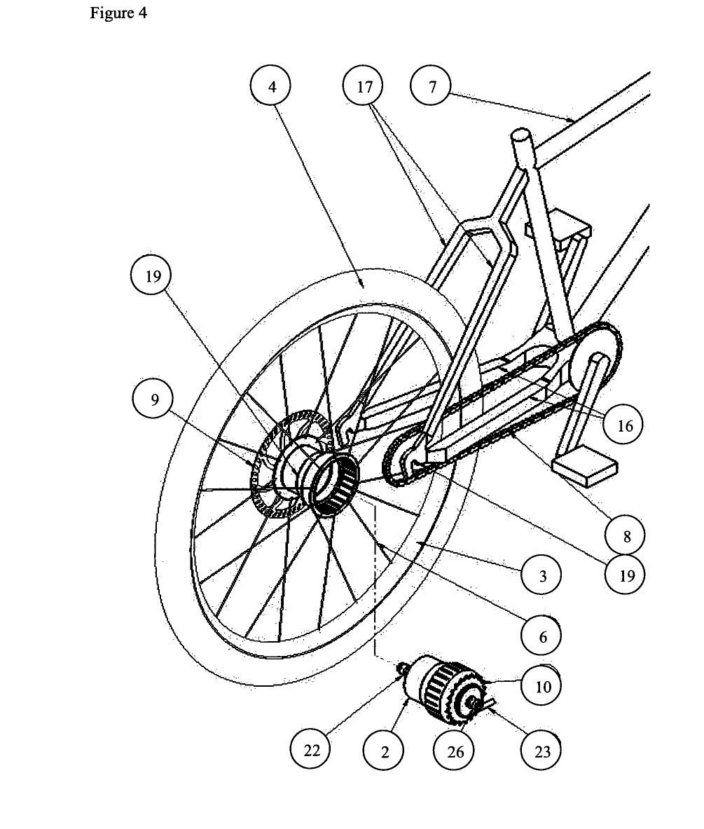

FIG. 4 shows an embodiment of the cartridge-based hub system after detachment from the bicycle frame, where the cartridge is fabricated with an integrated axle,

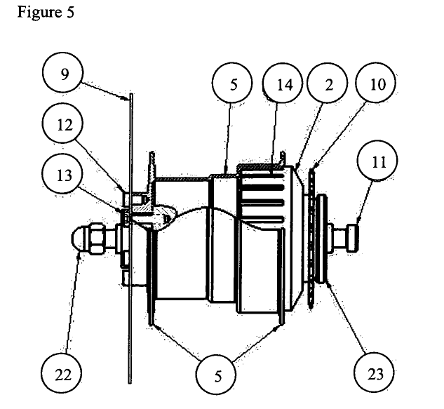

FIG. 5 shows in an embodiment the components of the cartridge-based hub system according to the present invention,

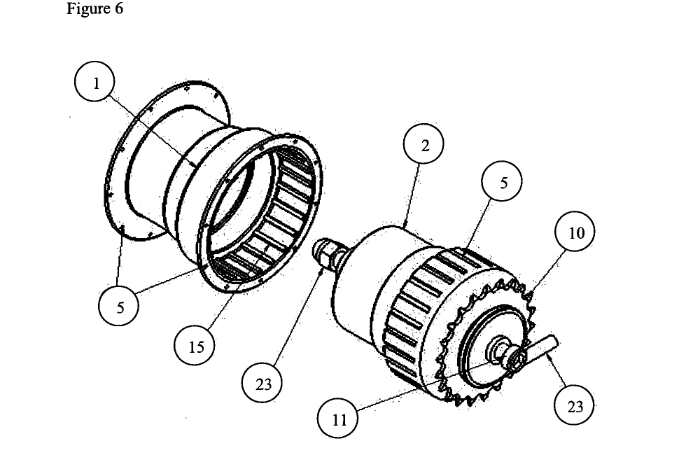

FIG. 6 shows attachment details between the cartridge-based hub system and the hub shell,

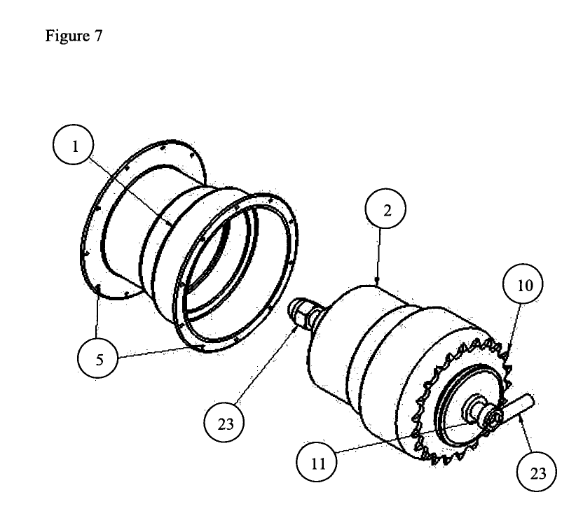

FIG. 7 shows an embodiment of the cartridge-based hub system according to the present invention, where the cartridge is fabricated so that it is attached to the hub shell with bolts and without splines, and

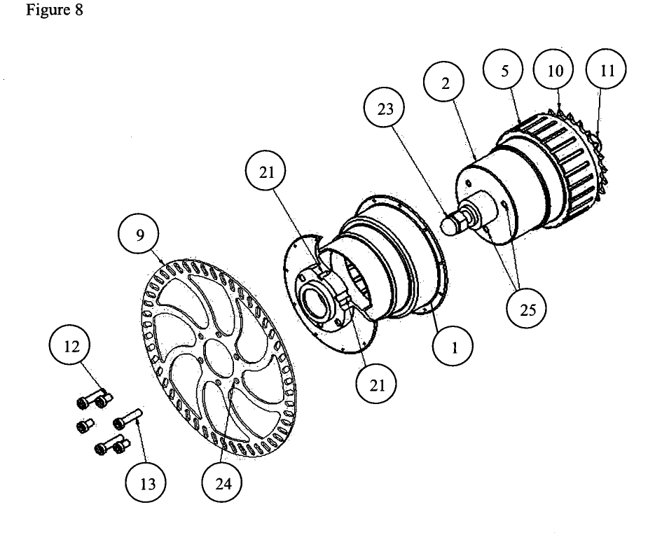

FIG. 8 shows the cartridge-based hub system's components according to a preferred embodiment.

Of FIG. 1 can be seen that the cartridge-based hub system is used on a standard diamond-shaped bicycle frame 7. Other frame shapes can also be used, the hub system can for example be used on frames 7 with a suspended rear wheel, or with monocoque-frames. Common for all these frames 7 will be that they have two mounts for two wheel axle mounts 19, and thereby chain stays 16 or seat stays 17 on each side of the hub shell 1, and that these stays 16, 17 and wheel axle mounts 19 are placed on the right and left side respectively, for maximum stability and optimum weight.

Furthermore, FIG. 1 shows how the cartridge-based hub system will appear mounted on the bicycle. The solution appears as a standard gear hub system, where a gear system is inseparably attached to a hub shell 1 and cannot without a significant operation and not without exposing the delicate internal mechanisms to the elements be detached from the hub shell 1. The hub shell 1 will be mounted in an appropriate manner to the wheel rim 3 and tire 4, so that this together appears just as a complete wheel. Certain wheels will use spokes 6 that are mounted to the hub shell 1 through spoke mounts 5. Other appropriate solutions for mounting the hub shell 1 to the wheel rim 3 can also be used, for example the known solution of a small number of wide aerodynamic wings fabricated in lightweight aluminum or carbon fiber, which attach the hub shell 1 to the wheel rim 3 and tire 4 without the use of this metal spokes 6 and spoke nipples. Such wheels will most often not need further adjustment after they have left the factory, as spoked wheels often do, as the wheel rim 3 and hub shell 1 often are fabricated as one integral part with the wings. A cartridge-based hub system does not discriminate between fastening mechanisms between tire 4 and hub shell 1.

The cartridge 2 will be mounted within the hub shell 1 and will therefore to a large extent not be visible to an observer. Smaller parts of the cartridge 2 that are not covered by the hub shell 2 can however be visible, for example the part of the cartridge 2 that sticks out of the hub shell 1 on the right or left side, or larger parts of the cartridge 2, if the hub shell 1 is fabricated in an open or partly open manner, or with transparent materials such as plastic, glass or thin layers of carbon fiber.

The particular internal mechanisms of the cartridge 2 are not in principle of the greatest relevance to this application, as there are a myriad of different internal solutions available that can be used with the cartridge-based hub system. Different power transfer solutions exist and are known technologies. For example the use of planetary gear systems, single speed, and fixie is widespread on bicycles, while CVT, NT and other solutions exist but are considered more experimental. Which internal gear solution is used is hence not the primary focus of this application. It is, however, natural to assume that one with such a cartridge-based hub system primarily seek to create opportunities for using cartridges 2 that contain a certain form of gear solution. Furthermore, it is natural to assume that one wishes to offer the opportunity for using the same cartridge 2 on different wheel sets or cartridges 2 with gear solutions with differing characteristics on the same wheel set. Furthermore it is natural to assume that a planetary gear solution is most appropriate for bicycles at the current stage in the evolution of gear system solutions for bicycles. Other gear solutions can however be used with the cartridge-based hub system for bicycles, as these are developed and made available in the market, or since certain user groups have certain desires. For example, one should be able to develop and use cartridges with planetary gear systems, CVT-gear systems, single-speed, fixie and other solutions in the same hub shell with a cartridge-based hub system according to the present application.

For reduction of speed of the bicycle rim brakes, disk brakes or other solutions can be used. Rim brakes are a known technology, and hub systems for bicycles with such brakes in their critical elements do not diverge from hub systems of disk brakes, apart from the latter not needing disk brake mounts on the hub/wheel. By use of disk brakes, it is desirable that a disk brake rotor 9 is mounted onto the wheel in an appropriate manner, for instance by splines, bolts or similar. This is known technology. As an objective with use of the cartridge solution is to enable effortless detachment of the cartridge 2 from the wheel, a possibility is to not attach the disc brake rotor 9 to the cartridge 2, but rather to the hub shell 1. It may though be desirable to use mechanisms where the disc brake rotor 9 is also attached to the cartridge 2, so that the rider will experience increased strength and rigidity in the system. To lock the cartridge 2 to the hub shell 1 some of the bolts 13 for the disc brake rotor 9 may penetrate the hub shell 1 and attach directly to the cartridge 2. Other types of quick releases for attachment of the disc brake rotor 9 can also be developed. A cartridge-based hub system may as such be characterized as containing attachment mechanisms for the disk brake rotor 9, or it may be provided without such contraptions.

FIG. 2 shows that the cartridge-based hub system can be used on bicycle frames 7 with suspension on the rear wheel, to emphasize that the hub system is not limited for use on a certain frame type. There exists today a myriad of different solutions for use of rear suspension on bicycles. Some have mono-joints, other have a large number of joints arranged in a complicated system to ensure optimal track of movement for the rear wheel as the rear suspension device is compressed. Common for the frames 7 with which the cartridge-based hub system is used, is that they have two wheel axle mounts 19, one on each side of the frame 7, and that the cartridge-based hub system is attached to the frame 7 in these two wheel axle mounts 19 via an axle 11.

FIG. 3 shows how the cartridge 2 can be separated from the hub shell 1 and how the wheel can be separated from the frame 7. In this case, the bicycle frame 7 has two chain stays 16 and two seat stays 17. These meet in the outer/rear part of the frame 7 and create a triangle 18 where they meet. In the outer part of the triangle 18 where chain stay 16 and seat stay 17 meet, there are attached to the frame 19 wheel axle mounts 19 for mounting of a wheel axle 11. However, for use of the cartridge-based hub system it is not critical that the frame 7 both has chain stays 16 and seat stays 17, as long as the frame 7 has wheel axle mounts 19 for attachment of the wheel and wheel axle 11 to the frame 7 on both the right and the left side of the frame 7. For example, the cartridge-based hub system can be used on frames with only chain stays 16, and no seat stays 17, or only with seat stays 17 but no chain stays 16. The chain 8 that drives the rear wheel is separated from the cartridge-based hub system when the cartridge 2 is separated from the hub shell 1.

On FIG. 3 we can see that the hub shell 1 has inner splines 15 that the cartridge's 2 complementary outer splines 14 can be threaded into. When the cartridge 2 is pushed into or mounted into the hub shell 1, the splines 14, 15 will prevent independent rotation of the cartridge 2 and the hub shell 1, meaning that the cartridge 2 and the hub shell 1 will rotate together.

In one embodiment the cartridge 2 is so provided that the axle 11 is separable from the cartridge 2, as shown in FIG. 3. This means that axles 11 with differing lengths and potentially thicknesses can be used, for example by use of an adapter. For attachment of the loose axle 11 to the frame 7, wheel axle nuts 22 or other appropriate mechanisms can be used.

The disc brake rotor 9 is in this embodiment attached to the hub shell 1. The wheel rim 3, spokes 6, and disk brake rotor 9 are joined together, and together these units virtually appear as a complete wheel, though without wheel axle 11, inner gear mechanisms, wheel bearings, free wheel mechanisms, and other parts that a wheel may typically contain. When the wheel is detached from the frame 7 the disc brake rotor 9 will be attached to the wheel, similar to standard non cartridge/based hubs for bicycles on the market today. In contrast to these, the disc brake rotor 9 on this version of the cartridge-based hub system will be attached to the hub shell 1 when the cartridge 2 with its wheel axle 11 and other typical inner components are separated from the rest of the wheel, with its hub shell 1, spokes 6, wheel rim 3 and tire 4.

FIG. 4 shows an embodiment of the cartridge-based hub system, where the cartridge 2 in contrast to the embodiment of FIG. 3 is provided with axle pegs 26 and without a detachable wheel axle 11, for attachment of the cartridge 2 to the frame 7 via wheel axle mounts 19 in the outer edges of the chain stays 16 and the seat stays 17. In this version the axle may be used to control potential gear mechanisms within the cartridge 2.

FIG. 5 shows a cartridge-based hub system with a detachable wheel axle 11. The cartridge 2 with a chain wheel 10 and wheel axle 11, is mounted within the hub shell 1 with an attached disk brake rotor 9, corresponding splines 14 in the outer surface of the cartridge 2 and inner splines 15 in the hub shell 1. The hub shell 1 is in this figure cut out to show how the cartridge 2 is mounted on the inside of the hub shell 1. The chain wheel 10 and detachable wheel axle 11 are mounted within the cartridge 2, which is mounted in the hub shell 1. On the wheel axle's 11 left side wheel axle nuts 22 can be seen, which lock the wheel axle 11 and the hub system to the wheel axle mounts 19 on the bicycle frame 7 for mounting and use. On the hub system's right side a chain wheel 10 and a unit for attachment of a gear shift wire 23 can be seen. The disc brake rotor 9 is attached to the hub shell 1. In this embodiment, the disc brake rotor 9 is attached to the hub shell 1 with three short bolts 12 and three long bolts 13. The short bolts 12 do not stretch far enough to penetrate the cartridge 2 but attach the disc brake rotor 9 to the hub shell 1. The long bolts 13 are longer, stretch far enough to penetrate the cartridge 2, and lock the disc brake rotor 9 and the cartridge 2 together. Independent rotation between the cartridge 2 and the hub shell 1 is prevented by splines 14 on the outside of the cartridge 2 which correspond with the inner splines 15 of the hub shell 1, and by the long bolts 13 that penetrate the disc brake rotor 9, hub shell 1 and the cartridge 2. The cartridge 2 will thereby appear as locked to the hub shell 1, and the cartridge 2 and hub shell 1 will function as a complete hub system, which a wheel for a bicycle can be built around. When the hub system is built into a wheel, spokes 6 will be drawn through spoke mounts 5 on the hub shell 1 in the ordinary manner. These spokes 6 are not in contact with the cartridge 2, which can thereby be pulled out of the hub shell 1 without requiring the spokes 6 and wheel rim 3 to be detached from the hub shell 1. Thereby one achieves that the inner mechanisms which a hub normally consist of, and which in the cartridge-based hub system are located in the cartridge 2; free wheel coupling, main wheel bearings, wheel axle 11 and power transfer mechanisms, for example a gear system, can in a sealed form be separated from the rest of the wheel without the latter having to be broken down into its individual parts; amongst others spokes 6, wheel rim 3 and tire 4.

FIG. 6 shows a version of the hub system consisting of the cartridge 2 with a detachable wheel axle 11 with a chain wheel 10 and outer splines 14 placed in the axial direction of the hub shell 1 with its spoke mounts 5 and inner splines 15 placed in the axial direction. A detachable wheel axle 11 is mounted in the cartridge 2 and wheel axle nuts 22 are mounted to the axle 11. To the right on the cartridge 2 attachment means for the gear shift wire 23 can be seen. For mounting of the cartridge 2 into the hub shell 1 the other splines 14 will have to be arranged against the inner splines 15 of the cartridge 2. The cartridge 2 will thereafter be pushed into and attached to the hub shell 1, and the inner 15 and outer splines 14 will prevent independent rotation of the cartridge 2 and the hub shell 1. The rotation can also be prevented in other manners, for example by use of long bolts 13, which lock the hub shell 1 to the cartridge 2. When the hub system is built into a wheel, spokes 6 are drawn through spoke mounts 5 on the hub shell 1. These spokes 6 are not in contact with the cartridge 2, and the cartridge 2 can thereby be pulled out of the hub shell 1 without the spokes 6 having to be loosened from the hub shell 1.

FIG. 7 shows a version of the hub system containing a hub shell 1 with spoke mounts 5, and cartridge 2 without splines. The cartridge 2 is pushed into the hub shell 1, and attached by another appropriate manner than the use of splines, for example by use of long bolts 13. On the right side of the cartridge a contraption for attachment of shifter wire 23 can be seen.

FIG. 8 shows the hub system consisting of long 13 and short bolts 12, disk brake rotor 9 with bolt holes 24, hub shell 1 with bolt holes for long bolts 21 and thread holes 20, spoke mounts 5, and cartridge 2 with chain wheel 10, outer splines 14, and the cartridges' thread holes 25 for the long bolts 13. The hub shell 1 is cut away to provide a view of the hub shell 1. Thread holes 20 for short bolts 12 will not necessarily penetrate the hub shell 1 completely, but bolt holes for long bolts 21 have to allow for long bolts 13 to attach the disk brake rotor 9 to be screwed through the hub shell 1 to enable the cartridge 2 to be attached to the hub shell 1 via the cartridge's thread holes 25. By the long bolts 13 penetrating the disk brake rotor 9, the hub shell 1 and cartridge 2, these three units will be connected to each other, and appear and be used as one unit.

The invention has now been explained by means of a non-limiting embodiment. A person skilled in the art will appreciate that it will be possible to implement a number of variations and modifications to the cartridge-based hub system as described within the scope of the invention as it is defined in the accompanying claims.

1. A cartridge-based hub system comprising:
a hub shell;
a sealed hub cartridge;
wherein the hub shell and the sealed hub cartridge are selectively connectable;
wherein the hub shell comprises means for wheel rim attachment; and
wherein the sealed hub cartridge comprises means for multispeed power transfer and means for axial attachment to a bicycle frame's corresponding right and left sides.

2. The cartridge-based based hub system according to claim 1, wherein the sealed hub cartridge and the hub shell are selectively connectable by means of at least one of splines, threads, magnets, bolts and other means suitable.

3. The cartridge-based hub system according to claim 1, wherein the sealed hub cartridge, in itself or with an adapter, has an outer circumference corresponding to the inner circumference of the hub shell.

4. The cartridge-based hub system according to claims 1, wherein splines for selective cartridge and hub shell connectability are arranged at least partially axially along the sealed hub cartridge's and/or the hub shell's lengths respectively and/or at least partially circumferently around the sealed hub cartridge outer casing and/or the hub shell inner casing respectively.

5. The cartridge-based hub system according to claim 1, wherein at least one bolt is operable to penetrate both the hub shell and the sealed hub cartridge.

6. The cartridge-based hub system according to claim 1, wherein the sealed hub cartridge comprises having wheel axle bearings.

7. The cartridge-based hub system according to claim 1, wherein the means for multispeed power transfer is provided by at least one of a planetary gear system, CVT-gear system, IVT-gear system, and other means suitable.

8. The cartridge-based hub system according to claim 1, wherein the cartridge-based hub system is selectively attachable to wheel axle mounts of the bicycle by means of at least one of a cartridge integrated axle, a cartridge penetrating thru-axle, cartridge attached axle-pegs, and other means suitable.

9. The cartridge-based hub system according to claim 1, wherein means for attaching a disk brake rotor is located on at least one of the hub shell and the sealed hub cartridge.

10. The cartridge-based hub system according to claim 1, wherein the hub shell is operable to transfer user induced torque to a wheel rim by means of at least one of spokes, disc wheel, composite wings, and other means suitable.

11. The cartridge-based hub system according to claim 1, wherein the means for rim attachment is mounted onto the hub shell in an equal or distinct distance from a wheel rim.

12. The cartridge-based hub system according to claim 1, wherein the sealed hub cartridge detachable hub shell at least partially covers the cartridge casing axially and/or circumferently.

13. The cartridge-based hub system according to claim 1, wherein a the multispeed cartridge is replacable with at least one of a cartridge containing at least one of a freewheeled single speed power transfer solution, a non-freewheeled solution, a derailleur cassette solution, and other means for appropriate power transfer.
